(19) United States
(12) Patent Application Publication
(10) Pub. No.: US 2008/0076027 A1
(43) Pub. Date: Mar. 27, 2008

(54) PROCESS FOR PRODUCING LITHIUM-CONTAINING COMPOSITE OXIDE FOR POSITIVE ELECTRODE OF LITHIUM SECONDARY BATTERY

(75) Inventors: Naoshi Saito, Chigasaki-shi (JP); Masaaki Ikemura, Chigasaki-shi (JP); Tokumitsu Kato, Chigasaki-shi (JP); Keiichi Kuwahara, Chigasaki-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: AGC Seimi Chemical Co., Ltd., Chigasaki-city (JP)

(21) Appl. No.: 11/942,208

(22) Filed: Nov. 19, 2007

Related U.S. Application Data
(63) Continuation of application No. PCT/JP2006/309849, filed on May 17, 2006.

(30) Foreign Application Priority Data
May 17, 2005 (JP) 2005-144506

(51) Int. Cl. H01M 4/50; H01M 4/52; C01G 45/12; C01G 53/04; C01G 51/04

(52) U.S. Cl. 429/231.1; 429/224; 429/231.3; 429/223; 423/599; 423/594.4; 423/594.6

(57) ABSTRACT

A process for producing a lithium-containing composite oxide such as a lithium-cobalt composite oxide for a lithium secondary battery, excellent in durability for charge/discharge cycles and excellent in low temperature characteristics, is provided.

A process for producing a lithium-containing composite oxide for positive electrode of lithium secondary battery, which is a process for producing a lithium-containing composite oxide represented by a general formula LiₚNₓM_{y}O_{z}Fₐ (wherein N is at least one type of element selected from the group consisting of Co, Mn and Ni, and M is at least one type of element selected from the group consisting of Al, an alkali earth metal element and a transition metal element other than N, 0.9≦p≦1.2, 0.97≦x≦1.00, 0<y≦0.03, 1.9≦z≦2.2, x+y=1 and 0≦a≦0.02), the process comprising a step of firing a blended product containing a lithium source, an N element source, an M element source, and as the case requires, a fluorine source in an oxygen-containing atmosphere; wherein as the N element source and the M element source, a material produced by drying a powder containing the N element source while a solution containing the M element source is sprayed to the powder, is used.

### TECHNICAL FIELD

The present invention relates to a process for producing lithium-containing composite oxide for a positive electrode of lithium secondary battery, which has a large volume capacity density, high safety, excellent durability for charge/discharge cycles, high press-density and high productivity; a positive electrode for lithium secondary battery containing the produced lithium-containing composite oxide; and a lithium secondary battery.

### BACKGROUND ART

In recent years, along with the progress in portable or codeless equipments, a demand is mounting for a non-aqueous electrolyte secondary battery which is small in size and light in weight and has a high energy density. As an active material for a non-aqueous electrolyte secondary battery, a composite oxide of lithium and a transition metal, such as LiCoO₂, LiNiO₂, LiNi_{0.8}Cu_{0.20}O₂, LiMn₂O₄ or LiMnO₂, has been known.

Especially, a lithium secondary battery employing a lithium-cobalt composite oxide (LiCoO₂) as a cathode active material and employing a lithium alloy or a carbon such as graphite or carbon fiber as a negative electrode, provides a high voltage at a level of 4 V and is widely used as a battery having a high energy density.

However, in a case of the non-aqueous type secondary battery employing LiCoO₂ as a cathode active material, further improvements of capacity density per a unit volume of a positive electrode layer and safety, have been desired, and there have been such problems as a problem of deterioration of cyclic properties that the battery discharge capacity gradually decreases as a charge/discharge cycle is repeated, a problem of weight capacity density, or a problem that the decrease of discharge capacity is significant at a low temperature.

In order to solve these problems, Patent Document 1 reports stabilization of crystal lattice of lithium-cobalt composite oxide and improvement of performances by substituting a part of cobalt element by elements such as manganese or copper by a so-called solid phase method in which raw material components are blended and fired in a state of solid phase. However, in this solid phase method, it was confirmed that although cyclic properties can be improved by the effect of the substituting elements, the thickness of the battery gradually increases as the charge/discharge cycle is repeated.

Further, Patent Document 2 reports improvement of performances of lithium-cobalt composite oxide by substituting a part of cobalt element by an element such as magnesium by a coprecipitation method. However, in this coprecipitation method, although more uniform substitution of element is possible, there are problems that the type or the concentration of substituting elements is limited and it is difficult to obtain a lithium-cobalt composite oxide having expected performances.

Patent Document 1: JP-A-5-242891

Patent Document 2: JP-A-2002-198051

### DISCLOSURE OF THE INVENTION

### Problems to be Solved by the Invention

It is an object of the present invention to provide a process for producing a lithium-containing composite oxide such as a lithium-cobalt composite oxide for a positive electrode of lithium secondary battery, having a large volume capacity density, high safety, excellent durability for charge/discharge cycles and excellent low-temperature characteristics, by substituting an element such as cobalt in a lithium-cobalt composite oxide by various types of substituting elements.

### Means of Solving the Problems

In order to solve the above problems, the present inventors have conducted extensive studies and as a result, they have discovered that in a case of substituting an element to be substituted such as cobalt in e.g. a lithium-containing composite oxide by a substituting element such as aluminum, magnesium or zirconium, by using specific means, the element to be substituted is uniformly substituted by the substituting element and high packing property is thereby maintained, and a lithium-cobalt composite oxide such as a lithium-containing composite oxide whose performances are significantly improved, is produced. Here, the above-mentioned element to be substituted means specifically at least one type of element selected from the group consisting of Co, Mn and Ni, which may be referred to as N element hereinafter. Further, the above-mentioned substituting element means specifically at least one type of element selected from the group consisting of Al, an alkali earth metal element and a transition metal element other than N, which may be referred to as M element hereinafter.

According to the present invention, as compared with the above-mentioned conventional solid phase method, an N element being an element to be substituted is substituted by various types of M elements being substituting elements uniformly at various types of concentrations, and thus, M element being a substituting element is uniformly present in a lithium-containing composite oxide obtained, whereby an expected effect can be obtained. Further, in the present invention, there is no restriction in the type or the concentration of substituting M element differently from the above-mentioned conventional coprecipitation method, and N elements can be substituted by various types of M elements at appropriate concentrations. For this reason, the lithium-containing composite oxide obtainable has excellent performances of a positive electrode of lithium secondary battery in terms of all of volume capacity density, safety, durability for charge/discharge cycles, press density and productivity.

The present invention has the following gists:

(1) A process for producing a lithium-containing composite oxide for positive electrode of lithium secondary battery, which is a process for producing a lithium-containing composite oxide represented by a general formula LiₚNₓM_{y}O_{z}Fₐ (wherein N is at least one type of element selected from the group consisting of Co, Mn and Ni, and M is at least one type of element selected from the group consisting of Al, an alkali earth metal element and a transition metal element other than N, 0.9≦p≦1.2, 0.97≦x≦1.00, 0<y≦0.03, 1.9≦z≦2.2, x+y=1 and 0≦a≦0.02), the process comprising a step of firing a blended product containing a lithium source, an N element source, an M element source, and as the case requires, a fluorine source in an oxygen-containing atmosphere;

wherein as the N element source and the M element source, a material produced by drying a powder containing the N element source while a solution containing the M element source is sprayed to the powder, is used.

(2) The process according to the above (1), wherein the solution containing M element source is a solution containing a compound having at least two carboxylic group(s) or hydroxyl group(s) in total in its molecule.

(3) The process according to the above (1) or (2), wherein the concentration of the compound having at least two carboxylic group(s) or hydroxyl group(s) in total in its molecule, in the solution containing M element is at most 30 wt %.

(4) The process according to any one of the above (1) to (3), wherein the drying treatment is conducted at a temperature of from 80 to 150° C.

(5) The process according to any one of the above (1) to (4), wherein the firing comprises a first-stage firing at from 250 to 700° C. and a subsequent second-stage firing at from 850 to 1,100° C.

(6) The process according to any one of the above (1) to (5), wherein the N element(s) is Co, Ni, a combination of Co and Ni, a combination of Mn and Ni or a combination of Co, Ni and Mn.

(7) The process according to any one of the above (1) to (6), wherein the M element in the solution containing M element source is at least one element selected from the group consisting of Zr, Hf, Ti, Nb, Ta, Mg, Cu, Sn, Zn and Al.

(8) The process according to any one of the above (1) to (7), wherein the drying and the spraying are conducted in an apparatus having stirring and heating functions.

(9) The process according to the above (8), wherein the apparatus having stirring and heating functions has a horizontal axis type stirring mechanism, a spray type liquid-injection mechanism and a heating mechanism.

(10) A positive electrode for lithium secondary battery containing the lithium-containing composite oxide produced by the method as defined in any one of the above (1) to (9).

(11) A lithium secondary battery employing the positive electrode as defined in the above (10).

### EFFECTS OF THE INVENTION

According to the present invention, it is possible to uniformly substitute an N element being an element to be substituted by various types of M elements being substituting elements at various types of appropriate concentrations, and thus, a process is provided with excellent productivity for producing a lithium-containing composite oxide such as a lithium-cobalt composite oxide for a positive electrode of lithium secondary battery, having a large volume capacity density, high safety, excellent durability for charge/discharge cycles and low-temperature properties.

### BEST MODE FOR CARRYING OUT THE INVENTION

The lithium-containing composite oxide for a positive electrode of lithium secondary battery according to the present invention, has a general formula LiₚNₓM_{y}O_{z}Fₐ. In the general formula, p, x, y, z and a are defined as described above. Among these, p, x, y, z and a are preferably as follows. 0.97≦p≦1.03, 0.99≦x<1.00, 0.0005≦y≦0.025, 1.95≦z≦2.05, x+y=1 and 0.001≦a≦0.01. Here, when a is larger than 0, a composite oxide a part of whose oxygen atoms is substituted by fluorine atoms, is formed, and in this case, safety of obtained cathode active material improves. In the present invention, total number of atoms of cation preferably equals to total number of atoms of anion, namely, the total of p, x and y preferably equals to the total of z and a.

The N element is at least one type of element selected from the group consisting of Co, Mn and Ni, and among these, Co, Ni, a combination of Co and Ni, a combination of Mn and Ni or a combination of Co, Ni and Mn is preferred.

The M element is at least one type of element selected from the group consisting of aluminum, an alkali earth metal and a transition metal element other than N element. Here, the transition metal element means a transition metal of Group 4, 5, 6, 7, 8, 9, 10 or 11. Among these, M element is preferably at least one element selected from the group consisting of Zr, Hf, Ti, Nb, Ta, Mg, Cu, Sn, Zn and Al. Particularly, from the viewpoints of e.g. capacity development property, safety and cycle durability, Zr, Hf, Ti, Mg or Al is preferred.

With respect to an N element source to be employed in the present invention, when the N element is cobalt, the N element source is preferably cobalt carbonate, cobalt hydroxide, cobalt oxyhydroxide or cobalt oxide, etc. Particularly, cobalt hydroxide or cobalt oxyhydroxide is preferred since they easily develop the property. Further, when the N element is nickel, the N element source is preferably nickel hydroxide or nickel carbonate. Further, when the N element is manganese, manganese carbonate is preferably employed.

When the N element contains at least two types of elements, they are preferably coprecipitated so that these elements are uniformly distributed in the material in an atomic level. As an N element source to be coprecipitated, a coprecipitated hydroxide, a coprecipitated oxyhydroxide, a coprecipitated oxide or a coprecipitated carbonate, etc. is preferred. When the N element is a combination of nickel and cobalt, the atomic ratio between nickel and cobalt is preferably from 90:10 to 70:30. Further, a part of cobalt may be substituted by aluminum or manganese. When the N element is a combination of nickel, cobalt and manganese, the atomic ratio among nickel, cobalt and manganese is preferably (from 10 to 50):(from 7 to 40):(from 20 to 70). Further, when the N element source is a compound containing nickel and cobalt, the compound is preferably Ni_{0.8}Co_{0.2}OOH, Ni_{0.8}CO_{0.2}(OH)₂, etc., when the N element source is a compound containing nickel and manganese, the compound is preferably Ni_{0.5}Mn_{0.5}OOH, etc., and when the N element source is a compound containing nickel, cobalt and manganese, the compound is preferably Ni_{0.4}CO_{0.2}Mn_{0.4}OOH or Ni_{1/3}Co_{1/3}Mn_{1/3}OOH, etc.

The lithium source to be employed in the present invention is preferably lithium carbonate or lithium hydroxide. Particularly, lithium carbonate is preferred since it is inexpensive. The fluorine source is preferably a metal fluoride, particularly preferably LiF or MgF₂, etc.

For production of the lithium-containing composite oxide according to the present invention, a solution containing M element source, preferably an aqueous solution containing M element source is employed. In this case, the M element source may be an inorganic salt such as an oxide, a hydroxide, a carbonate or a nitrate; an organic salt such as an acetate, an oxalate, a citrate, a lactate, a tartarate, a malate or a malonate; an organic metal chelate complex; or a compound produced by stabilizing a metal alkoxide by e.g. a chelate. However, in the present invention, the M element source is preferably one uniformly soluble in aqueous solution, such as a carbonate, a nitrate, an oxalate, a citrate, a lactate, a tartarate, a malate, a malonate or a succinate. Particularly, a citrate or a tartarate is more preferred since they have high solubility.

As the solution containing M element source, a solution containing one or at least two types of compounds having at least two carboxylic group(s) or hydroxyl group(s) in total in its molecule, is preferably employed for stabilizing the solution. When at least two carboxylic groups are present or hydroxyl group(s) is present in addition to carboxylic group(s), solubility of M element in the solution can be increased, such being more preferred. Particularly, a molecular structure containing 3 to 4 carboxylic groups and/or a molecular structure containing 1 to 4 hydroxyl group(s) in addition to carboxylic group(s), can increase the solubility, such being further preferred.

The number of carbon atoms of the compound having at least two carboxylic group(s) or hydroxyl group(s) in total in its molecule, is preferably from 2 to 8. The number of carbon atoms is particularly preferably from 2 to 6. The compound whose molecule having at least two carboxylic group(s) and/or hydroxyl group(s) in total in its molecule is specifically preferably citric acid, tartaric acid, oxalic acid, malonic acid, malic acid, racemic acid, lactic acid, ethylene glycol, propylene glycol, diethylene glycol, triethylene glycol, dipropylene glycol, polyethylene glycol, butanediol or glycerin. Particularly, citric acid, tartaric acid or oxalic acid is preferred since they can increase solubility of M element source and they are relatively inexpensive. When a carboxylic acid having high degree of acidity such as oxalic acid is employed, if pH of an aqueous solution is less than 2, an N element source to be admixed later is easily solved, and thus, it is preferred to admix a base such as an ammonium to make the pH at least 2 and at most 12. If pH exceeds 12, the N element source becomes soluble, such being undesirable.

Further, in the solution containing M element source, if the concentration of the compound having at least two carboxylic group(s) or hydroxyl group(s) in is total is too high, the viscosity of the aqueous solution becomes high, and it becomes difficult to uniformly blend the aqueous solution with another element source powder, and thus, the concentration is preferably from 0.1 to 30 wt %, particularly preferably from 1 to 25 wt %. In the present invention, as an N element source and an M element source, a product produced by drying a powder containing N element source while a solution containing M element source is sprayed to the powder is employed. In the present invention, it is necessary to carry out spraying of a solution containing M element source to a powder containing N element source and drying them at the same time, and for this purpose, the spraying is preferably carried out at a temperature of from 80 to 150° C., particularly preferably from 90 to 120° C. Further, the spraying of the solution containing M element source is preferably carried out so as to form a mist having a mist size of preferably from 0.1 to 250 μm, particularly preferably from 1 to 150 μm while the powder containing N element source is stirred.

As the method for drying a powder containing N element source while a solution containing M element source is sprayed to the powder, various types of specific means may be used. For example, such means may be means in which an aqueous solution containing M element source is sprayed to a powder containing N element source while the powder is blended by e.g. an axial mixer, a drum mixer or a turbulizer, or means in which an aqueous solution containing M element source is sprayed to a powder containing M element source while the powder is blended by a biaxial kneader to obtain a wet powder containing M element source and N element source, and water is removed from the wet powder by e.g. a spray dry method or a shelf dry method to dry the powder.

In the present invention, by using the above-mentioned means, the solution containing M element source is sprayed to a powder containing N element source while the powder is subjected to a drying treatment to produce the above N element source and M element source in advance, and the N element source and the M element source are blended with another element source, dried and fired to produce a lithium-containing composite oxide. Particularly, it is preferred that by such means as the following (A), (B) or (C), while a solution containing M element source is sprayed to a powder containing N element source, they are blended with another element source, dried and subsequently, thus obtained blended product is fired.

(A) While an N element source, and a fluorine source as the case requires, is blended and kneaded in an apparatus having both blending and drying functions, and they are blended and dried while a solution containing M element source is sprayed to them, and subsequently, a lithium source is blended with them.

(B) While an N element source, and a fluorine source as the case requires, is blended and kneaded in an apparatus having both blending and drying functions, they are blended and dried while a solution containing a lithium source and an M element source is sprayed.

(C) While a lithium source, an N element source, and a fluorine source as the case requires, are blended and kneaded in an apparatus having both blending and drying functions, and they are blended and dried while a solution containing M element source is sprayed.

In the above-mentioned means (A), (B) or (C), when an element source such as N element source is used in a form of powder, average particle size of the powder is not particularly limited, but in order to achieve good blending, the particle size is preferably from 0.1 to 25 μm, particularly preferably from 0.5 to 20 μm. Further, the blending ratio of element sources, is selected so as to achieve desired element ratio in the range of the above-mentioned general formula LiₚNₓM_{y}O_{z}Fₐ of the cathode active material to be produced in the present invention.

For the blending and drying of the solution containing M element source and another element source powder in such means as the above-mentioned (A), (B) or (C), it is preferred to use an apparatus having a spray type injection function and blending and drying functions such as a Loedige mixer or a solid air, whereby uniform blending and drying can be achieved by a single step. In this case, productivity is further improved and a lithium-containing composite oxide can be obtained, which has appropriate particle size without having excess agglomeration or pulverization, and which contains N element in which M element is uniformly mixed and M element. Further, as an apparatus for drying, for the reasons of uniformity of additive element and particle control, an apparatus having a horizontal axis type mixing mechanism, a spray type injection mechanism and a heating mechanism, such as a Loedige mixer apparatus, is particularly preferred.

The temperature at a time of blending and drying a solution containing M element source with a powder of another element source in such means as the above-mentioned (A), (B) or (C), is preferably from 80 to 150° C., particularly preferably from 90 to 120° C. A solvent in a mixed product of the element sources is not necessarily completely removed in this stage since it is removed in a subsequent firing step, but in a case where the solvent is water, since a large energy is required to remove water in the firing step, water is preferably removed as much as possible.

In the present invention, the above-mentioned N element source, M element source and another element source of a lithium-containing composite oxide, are blended and dried so as to achieve desired element ratio in the range of the above-mentioned general formula LiₚNₓM_{y}O_{z}Fₐ of a cathode active material to be produced. A blended and dried product of element sources of the lithium-containing composite oxide obtained, is blended with another material as the case requires, and fired in an oxygen-containing atmosphere. This firing is preferably carried out under the conditions of from 800 to 1,100° C. for from 2 to 24 hours.

Further, in the present invention, the above firing in an oxygen-containing atmosphere is preferably carried out in a plurality of stages, more preferably in two stages. In the case of two-stage firing, it is preferred that a first-stage firing is carried out at from 250 to 700° C., and a second-stage firing of the fired product is carried out at from 850 to 1,100° C. Particularly preferably, the firing temperature of the first stage is from 400 to 600° C., and the firing temperature of the second stage is from 900 to 1,050° C. The temperature rising speeds to the firing temperatures may be large or small, but from the viewpoint of productivity, the speeds are preferably from 0.1 to 20° C./min, particularly preferably from 0.5 to 10° C./min.

In the lithium-containing composite oxide obtainable by conducting firing and subsequent pulverization in the above manner, particularly in a case where N element is cobalt, the average particle size D50 is preferably from 5 to 15 μm, particularly preferably from 8 to 12 um, and its specific surface area is preferably from 0.2 to 0.6 is m²/g, particularly preferably from 0.3 to 0.5 m²/g. Further, an integral width of a (110) plane diffraction peak of 2θ=66.5±1° measured by a powder X-ray diffraction analysis using CuKα rays, is preferably from 0.08 to 0.14°, particularly preferably from 0.08 to 0.12°, and the press density is preferably from 3.05 to 3.50 g/cm³, particularly preferably from 3.10 to 3.40 g/cm³. In the present invention, the press density is an apparent density of a lithium-containing composite oxide powder pressed by a pressure of 0.3 t/cm².

In a case of producing a positive electrode for lithium secondary battery from the lithium-containing composite oxide, a carbon type conductive material such as acetylene black, graphite or ketjen black and a binder are blended with the lithium-containing composite oxide powder. For such a binder, preferably, polyvinylidene fluoride, polytetrafluoroethylene, polyamide, carboxymethyl cellulose, an acrylic resin or the like is employed. The powder of lithium-containing composite oxide of the present invention, a conductive material and a binder are blended with a solvent or a dispersion medium to produce a slurry or a kneaded product. The slurry or the kneaded product is supported by a positive electrode current collector of e.g. an aluminum foil or a stainless steel foil by e.g. coating, to produce an electrode for lithium secondary battery.

In a lithium secondary battery employing a lithium-containing composite oxide of the present invention for a cathode active material, e.g. a film of a porous polyethylene or a porous polypropylene may be employed as a separator. Further, as the solvent of the electrolytic solution of the battery, various types of solvents may be employed, and among these, a carbonate ester is preferred. For the carbonate ester, each of a cyclic type and a chain type may be employed. As the cyclic carbonate ester, propylene carbonate, ethylene carbonate (EC) etc. may be mentioned. As the chain carbonate ester, dimethyl carbonate, diethyl carbonate (DEC), ethyl methyl carbonate (EMC), methyl propyl carbonate, methyl isopropyl carbonate etc. may be mentioned.

In the present invention, any one of the above-mentioned carbonate ester may be used alone or two or more types of them may be used as a mixture. Further, they may be used as a mixture with other solvents. Further, according to the material of the anode active material, when a chain carbonate ester and a cyclic carbonate ester are used in combination, discharge properties, cycle durability and charge/discharge efficiency can be improved in some cases.

Further, in the above-mentioned solvent for electrolytic solution, a gel polymer electrolyte containing vinylidene fluoride-hexafluoropropylene copolymer (e.g. product name KYNAR manufactured by ELF Atochem) or a vinylidene fluoride-perfluoropropyl vinyl ether copolymer, may be blended for use. Electrolyte(s) to be incorporated in the above-mentioned electrolytic solution or polymer electrolyte, is preferably at least one type of lithium salt containing as anion ClO₄⁻, CF₃SO₃⁻, BF₄⁻, PF₆⁻, AsF₆⁻, SbF₆⁻, CF₃CO₂— or (CF₃SO₂)₂N⁻. The amount of the electrolyte is preferably adjusted so that its concentration becomes from 0.2 to 2.0 mol/L (liter) based on the electrolytic solution or the polymer electrolyte. If the concentration deviates from this range, the ion conductivity decreases to decrease electric conductivity of the electrolyte. The concentration is particularly preferably from 0.5 to 1.5 mol/L.

In a lithium battery employing the lithium-containing composite oxide according to the present invention as the cathode active material, a material capable of absorbing and discharging lithium ion is employed as an anode active material. The material forming the anode active material is not particularly limited, and for example, lithium metal, a lithium alloy, a carbon material, a carbon compound, a silicon carbide compound, a silicon oxide compound, titanium sulfide, a boron carbide compound or an oxide containing a metal of Group 14 or 15 of Periodic Table as a main component, is mentioned. As the carbon material, one produced by thermally decomposing an organic material under various thermal decomposition conditions, an artificial graphite, is natural graphite, soil graphite, exfoliated graphite, flake graphite etc. may be employed. Further, as the oxide, a compound containing tin oxide as the main component may be employed. As the negative electrode current collector, a copper foil, a nickel foil etc. is employed. Such a negative electrode is preferably produced by kneading the above-mentioned active material with an organic solvent to produce a slurry and coating a metal foil electric collector with the slurry, drying and pressing them.

The shape of the lithium battery employing the lithium-containing composite oxide of the present invention as the cathode electrode active material, is not particularly limited. The shape may be appropriately selected according to the application from e.g. a sheet shape, a film shape, a folded shape, a wounded cylindrical shape with bottom and a button shape.

### EXAMPLES

Now, the present invention will be explained in further detail with reference to Examples and Comparative Examples. However, the present invention is by no means restricted to such specific Examples.

### Example 1

5,000 g of commercially available cobalt hydroxide (content of cobalt: 61.5 wt %, average particle size D50: 13.1 μm) and 1,956 g of lithium carbonate (specific surface area: 1.2 m²/g) were weighed and put in a Loedige mixer apparatus M20 (manufactured by MATSUBO CORPORATION).

51 g of commercially available magnesium carbonate powder and 74 g of citric acid were added to 3,000 g of water and 39 g of ammonium is subsequently added to them to obtain an aqueous solution of carboxylate (concentration of carboxylate: 2.4 wt %) of pH 9.5 in which magnesium is uniformly dissolved. The above-mentioned blended product of cobalt hydroxide and lithium carbonate was stirred in the above-mentioned Loedige mixer apparatus at 250 rpm, to be blended and dried at 105° C. while the above-mentioned aqueous solution of carboxylate was sprayed to the blended product uniformly by a spraying nozzle to obtain a precursor having a composition of LiCu_{0.99}Mg_{0.01}.

The precursor was fired in an air at 950° C. for 12 hours to obtain a fired product, and the fired product was pulverized to obtain a lithium-containing composite oxide powder of substantially spherical shape in which primary particles are agglomerated and having a composition of LiCo_{0.99}Mg_{0.01}O₂. The particle size distribution of the powder was measured in water by using a laser scattering type particle size distribution measurement apparatus, and as a result, the average particle size D50 was 13.3 μm, D10 was 7.2 μm, and D90 was 18.6 μm and the specific surface area obtained by BET method was 0.34 m²/g.

With respect to the lithium-containing composite oxide powder, an X-ray diffraction spectrum was measured by using an X-ray diffraction apparatus (model RINT 2100, manufactured by Rigaku Corporation). In the powder X-ray diffraction analysis using CuKα rays, the integral width of diffraction peak of (110) plane at 2θ=66.5±1° was 0.114°. The press density of this powder was 3.07 g/cm³. 10 g of this powder was dispersed in 100 g of purified water, filtered and subjected to a potentiometric titration with 0.1 N HCl to measure the amount of remaining alkali, and as a result, it was 0.02 wt %.

The above-mentioned lithium-containing composite oxide powder, an acetylene black and a polyvinylidene fluoride powder were mixed in a weight ratio of 90/5/5, N-methylpyrrolidone was added to the mixture to form a slurry, and one side of an aluminum foil was coated with the slurry of 20 μm thick by a doctor blade. Then, the coated product was dried and rolled five times by using a roll press to produce a positive electrode body sheet for lithium battery.

A member produced by punching out the positive electrode sheet was employed as a positive electrode, a metal lithium foil of 500 μm thick was employed as a negative electrode, a nickel foil of 20 μm thick was employed as a negative electrode electric collector, a porous polypropylene of 25 um thick was employed as a separator, and further, LiPF₆/EC+DEC (1:1) solution (It means a blended solution of EC+DEC at a weight ratio of 1:1 containing LiPF₆ as a solute. This definition is basically also applied to solutions described later.) having a concentration of 1 M was employed to assemble two sets of simple sealed cell type lithium batteries made of stainless steel in an argon globe box.

One of the batteries was charged to 4.3 V at a load current of 75 mA per 1 g of the cathode active material at 25° C., and discharged to 2.5 V at a load current of 75 mA per 1 g of the cathode active material, to measure the initial discharge capacity. Further, the density of the electrode layer was obtained. Further, with respect to the battery, 30 cycles of charge/discharge cycle test was subsequently carried out. As a result, the initial weight capacity density of the positive electrode layer at 25° C. at from 4.3 to 2.5 V was 160 mAh/g, and the volume retention ratio after the 30 charge/discharge cycles, was 98.3%.

Further, the other battery was charged at 4.3 V for 10 hours, disassembled in an argon globe box to take out a positive electrode body sheet after charge, the positive electrode body sheet was cleaned and punched out into a diameter of 3 mm, sealed in an aluminum capsule together with EC and heated in a scanning type differential calorimeter at a temperature-rising speed of 5° C./min to measure the heat generation starting temperature. As a result, the heat generation starting temperature of the product charged to 4.3 V was 163° C.

### Example 2

In 134.6 g of commercially available magnesium nitrate hexahydrate, 44.5 g of diethylene glycol and 62.9 g of triethylene glycol were added and completely dissolved, and thereafter, 1,404 g of ethanol was added and stirred to obtain an additive solution. The concentration of a compound having at least two hydroxyl groups in the solution was 6.5 wt %.

In the same manner as Example 1, 5,000 g of cobalt hydroxide and 1,956 g of lithium carbonate were weighed and put in a Loedige mixer apparatus M20 (manufactured by MATSUBO CORPORATION), they were stirred at 250 rpm, blended and dried at 105° C. while the above additive solution was uniformly sprayed to them by a spray nozzle to obtain a precursor having a composition of LiCo_{0.99}Mg_{0.01}.

The precursor was fired in the air at 950° C. for 12 hours, followed by pulverizing it to obtain a lithium-containing composite oxide powder of substantially spherical shape having a composition of LiCO_{0.99}Mg_{0.01}O₂. With respect to the powder, the average particle size was measured by using a laser scattering type particle size distribution measurement apparatus, and as a result, the average particle size D50 was 13.5 μm, D10 was 7.5 μm, D90 was 18.8 μm and the specific surface area obtained by a BET method was 0.33 m²/g. In a powder X-ray diffraction analysis, the integral width of diffraction peak of (110) plane at 2θ=66.5±1° was 0.112°. The press density of this powder was 3.09 g/cm³, and the amount of remaining alkali obtained by a potentiometric titration was 0.02 wt %.

By using the above lithium-containing composite oxide powder, in the same manner as Example 1, a positive electrode body was prepared, a battery was assembled to measure its performances. The initial weight capacity density of its positive electrode layer at 25° C. at from 4.3 to 2.5 V was 160 mAh/g, and capacity retention rate after 30 charge/discharge cycles was 98.2%. Further, the heat generation starting temperature of a product charged at 4.3 V was 164° C.

### Example 3

25 g of magnesium carbonate, 62 g of commercially available aluminum citrate and 64 g of citric acid were incorporated in a 3,000 g of purified water and dissolved to obtain an aqueous solution of carboxylate (concentration of carboxylate: 3.8 wt %) of pH 2.9 in which magnesium and aluminum were uniformly dissolved. In the same manner as Example 1, a blended product of 5,000 g of cobalt hydroxide and 1,956 g of lithium carbonate were put in a Loedige mixer apparatus, stirred at 250 rpm, blended and dried at 100° C. while the above-mentioned aqueous solution of carboxylate was sprayed to the blended product uniformly by a spraying nozzle to obtain a precursor having a composition of LiCo_{0.99}Mg_{0.005}Al_{0.005}.

The precursor was fired in the air at 950° C. for 12 hours, and pulverized to obtain a lithium-containing composite oxide powder of substantially spherical shape having a composition of LiCo_{0.99}Mg_{0.005}Al_{0.005}O₂. With respect to the powder, the average particle size was measured by using a laser scattering type particle size distribution measurement apparatus, and as a result, the average particle size D50 was 13.2 μm, D10 was 7.2 μm, D90 was 18.6 μm and the specific surface area obtained by a BET method was 0.34 m²/g. Further, in the powder X-ray diffraction analysis, the integral width of diffraction peak of (110) plane at 2θ=66.5±1° was 0.114°. The press density of this powder was 3.07 g/cm³, and the amount of remaining alkali obtained by a potentiometric titration was 0.02 wt %.

By using the above lithium-containing composite oxide powder, in the same manner as Example 1, a positive electrode body was prepared and a battery was assembled to measure its performances. The initial weight capacity density of its positive electrode layer at 25° C. at from 2.5 to 4.3 V was 160 mAh/g, and the capacity retention rate after 30 charge/discharge cycles was 98.9%. Further, the heat generation starting temperature of a product charged at 4.3 V was 166° C.

### Example 4

A precursor having a composition of LiCo_{0.99}Mg_{0.005}Al_{0.005} was obtained in the same manner as Example 3 except that only a cobalt hydroxide powder was put in a Loedige mixer, stirred at 250 rpm, blended and dried at 110° C. while the aqueous solution of carboxylate was sprayed to the powder by a spray nozzle. 1,917 g of lithium carbonate powder and 27.5 g of lithium fluoride powder were weighed and blended with the precursor obtained, and thereafter, they were fired under the same conditions of Example 1 to obtain a fired product having a composition of LiCu_{0.99}Mg_{0.005}Al_{0.005}O_{1.995}F_{0.005}.

The fired product was pulverized to obtain a lithium-containing composite oxide powder constituted by agglomerated primary particles, and the particle size distribution was measured in water by using a laser scattering type particle size distribution measurement apparatus. As a result, the average particle size D50 was 13.4 μm, D10 was 7.3 μm, D90 was 18.7 μm and the specific surface area obtained by a BET method was 0.37 m²/g.

With respect to the powder, an X-ray diffraction spectrum was measured by using an X-ray diffraction apparatus (model RINT 2100, manufactured by Rigaku Corporation). In the powder X-ray diffraction analysis using CuKα rays, the integral width of diffraction peak of (110) plane at 2θ=66.5±1° was 0.110°. The press density of this powder was 3.09 g/cm³. Further, 10 g of this powder was dispersed in 100 g of purified water, filtered and subjected to a potentiometric titration with 0.1 N HCl to measure the amount of remaining alkali, and as a result, it was 0.01 wt %.

Using the above lithium-containing composite oxide powder, in the same manner as Example 1, a positive electrode body was prepared and a battery was assembled to measure the performances. The initial weight capacity density of its positive electrode layer was 160 mAh/g, and the capacity retention rate after the 30 charge/discharge cycles was 99.4%. The heat generation starting temperature of a 4.3 V charged product was 171° C.

### Example 5

A lithium-containing composite oxide powder having a composition of LiAl_{0.01}CO_{0.975}Mg_{0.01}Zr_{0.005}O₂ was obtained in the same manner as Example 3 except that 5,000 g of cobalt hydroxide and 1,986 g of lithium carbonate powder were put in a Loedige mixer apparatus, and that an aqueous solution of carboxylate (concentration of carboxylate: 16 wt %) of pH 9.4 was employed, which was produced by adding 162 g of an aqueous solution of zirconyl carbonate ammonium (NH₄)₂[Zr(CO₃)₂ (OH)₂] containing 15.1 wt % of Zr to an aqueous solution of carboxylate in which 127 g of ammonium citrate, 51 g of magnesium carbonate and 206 g of citric acid were dissolved in 1,000 g of water. The press density of the powder was 3.11 g/cm³.

Further, using this powder, in the same manner as Example 1, a positive electrode body was produced and a battery was assembled to measure the performances. The initial weight capacity density of its positive electrode layer was 161 mAh/g, the capacity retention rate after the 30 cycles was 99.1% and the heat generation starting temperature was 171° C.

### Example 6

A precursor was prepared in the same manner as Example 5 except that 5,000 g of cobalt hydroxide was put in a Loedige mixer apparatus and that as the aqueous solution, and that an aqueous solution of carboxylic acid (concentration of carboxylate: 19 wt %) of pH 9.5 was employed, which was produced by adding 325 g of an aqueous solution of zirconyl carbonate ammonium (NH₄)₂[Zr(CO₃)₂(OH)₂] containing 15.1 wt % of Zr to a solution in which 158 g of commercially available aluminum lactate, 52 g of magnesium carbonate and 283 g of citric acid were dissolved in 1,000 g of water. A precursor obtained and 1,997 g of lithium carbonate were blended and fired at 950° C. for 12 hours to obtain a lithium-containing composite oxide powder having a composition of LiAl_{0.01}CO_{0.97}Mg_{0.01}Zr_{0.01}O₂. The press density of the powder was 3.11 g/cm³.

Further, using this powder, in the same manner as Example 1, a positive electrode body was produced and a battery was assembled to measure the performances. The initial weight capacity density of its positive electrode layer was 159 mAh/g, the capacity retention rate after the 30 cycles was 99.0% and the heat generation starting temperature was 169° C.

### Example 7

A lithium-containing composite oxide powder was prepared in the same manner as Example 6 except that 5,108 g of commercially available cobalt oxyhydroxide (content of cobalt: 61.5 wt %, average particle size D50: 14.7 μm) was employed instead of cobalt hydroxide. The average particle size D50 of the lithium-containing composite oxide powder having a composition of LiAl_{0.01}Cu_{0.97}Mg_{0.01}Zr_{0.01}O₂ obtained was 14.9 μm and its press density was 3.15 g/cm³.

Further, using this powder, in the same manner as Example 1, a positive electrode body was produced and a battery was assembled to measure the performances.

The average weight capacity density of its positive electrode layer was 159 mAh/g, the capacity retention rate after the 30 cycles was 99.2% and the heat generation starting temperature was 170° C.

### Example 8

A lithium-containing composite oxide powder was prepared in the same manner as Example 6 except that 4,207 g of commercially available tricobalt tetraoxide (content of cobalt: 73.1 wt %, average particle size D50: 15.7 μm) instead of cobalt hydroxide. The average particle size D50 of the lithium-containing composite oxide powder having a composition of LiAl_{0.01}Cu_{0.97}Mg_{0.01}Zr_{0.01}O₂ obtained was 15.2 μm and its press density was 3.07 g/cm³.

Further, using this powder, in the same manner as Example 1, a positive electrode body was produced and a battery was assembled to measure the performances.

The initial weight capacity density of its positive electrode layer was 159 mAh/g, the capacity retention rate after the 30 cycles was 99.1% and the heat generation starting temperature was 169° C.

### Example 9

A precursor was prepared in the same manner as Example 6 except that 5,000 g of cobalt hydroxide was put in a Loedige mixer apparatus and that as the aqueous solution, and that an aqueous solution produced by adding 61 g of an aqueous solution of titanium lactate [(OH)₂Ti(C₃H₅O₂)₂] containing 8.1 wt % of titanium to a solution in which 158 g of commercially available aluminum lactate, 52 g of magnesium carbonate and 91 g of glyoxylic acid were dissolved in 1,000 g of water, was employed.

The precursor obtained and 1,997 g of lithium carbonate were blended, its temperature was raised in the air to 500° C. at a temperature-rising speed of 7° C./min, is and the blended product was subjected to a first-stage firing at 500° C. for 5 hours. Subsequently, without pulverizing the product into particles or a powder, the temperature of the product as it was raised to 950° C. at a temperature-rising speed of 7° C./min, and subjected to a second-stage firing in the air at 950° C. for 14 hours. The press density of a lithium-containing composite oxide powder having a composition of LiAl_{0.01}CO_{0.978}Mg_{0.01}Ti_{0.002}O₂ obtained was 3.16 g/cm³.

Further, using this powder, in the same manner as Example 1, a positive electrode body was produced and a battery was assembled to measure the performances. The initial weight capacity density of its positive electrode layer was 159 mAh/g, the capacity retention rate after the 30 charge/discharge cycles was 98.9% and the heat generation starting temperature was 167° C.

### Example 10

A precursor having a composition of LiNi_{0.33}CO_{0.33}Mn_{0.33}Mg_{0.01} was prepared in the same manner as Example 1 except that 4,724 g of NiCoMn coprecipitated oxyhydroxide (Ni/Co/Mn=1/1/1, average particle size D50: 10.3 μm) was employed instead of cobalt hydroxide. The precursor was fired in the air at 950° C. for 12 hours to obtain a lithium-containing composite oxide powder having a composition of LiNi_{0.33}CO_{0.33}Mn_{0.33}Mg_{0.01}O₂.

The average particle size D50 of a powder obtained by pulverizing the fired product was 10.2 μm, the specific surface area obtained by a BET method was 0.50 m²/g. The press density was 2.90 g/cm³.

Performances as characteristics of cathode active material of lithium secondary battery were obtained, and as a result, the initial weight capacity density at 25° C. at from 4.3 to 2.5 V was 160 mAh/g, and the capacity retention rate after the 30 charge/discharge cycles was 97%. Further, the heat generation starting temperature of a 4.3 V charged product was 193° C.

### Comparative Example 1

A lithium-containing composite oxide powder having a composition of LiCoO₂ was obtained in the same manner as Example 1 except that 5,000 g of cobalt hydroxide, 1,956 g of lithium carbonate and 51 g of magnesium carbonate were dried and blended by using a drum type mixer without adding an aqueous solution of carboxylate, and thereafter, the product was fired in the air at 950° C. for 12 hours and pulverized. The average particle size D50 of the powder was 13.2 μm, and the press density was 3.01 g/cm³.

Further, by using the powder, in the same manner as Example 1, a positive electrode body was produced and a battery was assembled to measure the performances. The initial weight capacity density of its positive electrode layer was 160 mAh/g, the capacity retention rate after the 30 cycles was 95.1% and the heat generation starting temperature was 161° C.

### Comparative Example 2

The sample was prepared in the same manner as Example 6 except that a drum type mixer was used instead of a Loedige mixer apparatus. Namely, 5,000 g of cobalt hydroxide powder was put in a drum type mixer apparatus. Meanwhile, an aqueous solution of carboxylate (concentration of carboxylate: 19 wt %) of pH 9.5 was prepared by adding 325 g of an aqueous solution of zirconium carbonate ammonium (NH₄)₂ [Zr(CO₃)₂(OH)₂] containing 15.1 wt % of Zr to a solution in which 158 g of commercially available aluminum lactate, 52 g of magnesium carbonate and 283 g of citric acid were dissolved in 1,000 g of water, and the aqueous solution of carboxylate of pH 9.5 was dropped and blended with the cobalt hydroxide powder in the apparatus at a room temperature. A wet powder after the drop of aqueous solution was dried by a shelf-type dryer to obtain a precursor of Al_{0.01}Co_{0.97}Mg_{0.01}Zr_{0.01}. The precursor formed an agglomerated body when it was dry.

The precursor obtained and 1,997 g of lithium carbonate were blended, fired at 950° C. for 12 hours and pulverized to obtain a lithium-containing composite oxide powder having a composition of LiAl_{0.01}Co_{0.97}Mg_{0.01}Zr_{0.01}O₂. The average particle size D50 of the powder measured by using a laser scattering type particle size distribution measurement apparatus was 20.5 μm, and its press density was 3.01 g/cm³. The amount of remaining alkali in the is powder was obtained by a potentiometric titration, and as a result, it was 0.06 wt %.

Further, by using the powder, in the same manner as Example 1, a positive electrode body was produced and a battery was assembled to measure the performances. The initial weight capacity density of its positive electrode layer was 156 mAh/g, the capacity retention rate after the 30 cycles was 97.0% and the heat generation starting temperature was 163° C.

### Comparative Example 3

A sample was prepared in the same manner as Example 6 except that 5,000 g of cobalt hydroxide was put in a Loedige mixer and that an aqueous solution of carboxylate (concentration of a carboxylic compound in the solution: 19 wt %) of pH 9.5 was prepared by adding 325 g of an aqueous solution of zirconium carbonate ammonium (NH₄)₂[Zr (CO₃)₂(OH)₂] containing 15.1 wt % of Zr to a solution in which 158 g of commercially available aluminum lactate, 52 g of magnesium carbonate and 283 g of citric acid were dissolved in 1,000 g of water, and the aqueous solution of carboxylate of pH 9.5 was dropped in the material without using a spray apparatus. A wet powder after the drop was dried at 100° C. as it was stirred. The dried precursor formed a granulated product when it was dry, and it was not possible to subsequently convert it to a lithium salt.

### INDUSTRIAL APPLICABILITY

The lithium-containing composite oxide obtainable by the present invention is widely used as e.g. a cathode active material for a positive electrode of lithium secondary battery. When the lithium-containing composite oxide is used as a cathode active material for a positive electrode of lithium secondary battery, a lithium secondary battery was provided, which has a positive electrode having a large volume capacity density, high safety, excellent charge and discharge cycle durability, and excellent low temperature characteristics.

The entire disclosure of Japanese Patent Application No. 2005-144506 filed on May 17, 2005 including specification, claims and summary is incorporated herein by reference in its entirety.

What is claimed is:

1. A process for producing lithium-containing composite oxide for positive electrode of lithium secondary battery, which is a process for producing a lithium-containing composite oxide represented by a general formula LiₚNₓM_{y}O_{z}Fₐ (wherein N is at least one type of element selected from the group consisting of Co, Mn and Ni, and M is at least one type of element selected from the group consisting of Al, an alkali earth metal element and a transition metal element other than N, 0.9≦p≦1.2, 0.97≦x<1.00, 0<y≦0.03, 1.9≦z≦2.2, x+y=1 and 0≦a≦0.02), the process comprising a step of firing a blended product containing a lithium source, an N element source, an M element source, and as the case requires, a fluorine source in an oxygen-containing atmosphere;
wherein as the N element source and the M element source, a material produced by drying a powder containing the N element source while a solution containing the M element source is sprayed to the powder, is used.

2. The process according to claim 1, wherein the solution containing M element source is a solution containing a compound having at least two carboxylic group(s) or hydroxyl group(s) in total in its molecule.

3. The process according to claim 1, wherein the concentration of the compound having at least two carboxylic group(s) or hydroxyl group(s) in total in its molecule, in the solution containing M element is at most 30 wt %.

4. The process according to claim 1, wherein the drying treatment is conducted at a temperature of from 80 to 150° C.

5. The process according to claim 1, wherein the firing comprises a first-stage firing at from 250 to 700° C. and a subsequent second-stage firing at from 850 to 1,100° C.

6. The process according to claim 1, wherein the N element(s) is Co, Ni, a combination of Co and Ni, a combination of Mn and Ni or a combination of Co, Ni and Mn.

7. The process according to claim 1, wherein the M element in the solution containing M element source is at least one element selected from the group consisting of Zr, Hf, Ti, Nb, Ta, Mg, Cu, Sn, Zn and Al.

8. The process according to claim 1, wherein the drying and the spraying are conducted in an apparatus having stirring and heating functions.

9. The process according to claim 8, wherein the apparatus having stirring and heating functions has a horizontal axis type stirring mechanism, a spray type liquid-injection mechanism and a heating mechanism.

10. A positive electrode for lithium secondary battery containing the lithium-containing composite oxide produced by the method as defined in claim 1.

11. A lithium secondary battery employing the positive electrode as defined in claim 10.
